(19) United States
(12) Patent Application Publication
(10) Pub. No.: US 2015/0353175 A1
(43) Pub. Date: Dec. 10, 2015

(54) WATERCRAFT WITH FLOODING CHAMBER

(71) Applicant: CAYAGO GMBH, Kitzbühel (AT)

(72) Inventor: Hans Peter WALPURGIS, Ellmau (AT)

(73) Assignee: CAYAGO GMBH, Kitzbühel (AT)

(21) Appl. No.: 14/761,112

(22) PCT Filed: Dec. 23, 2013
(86) PCT No.: PCT/EP2013/077896

§ 371 Date: Jul. 15, 2015

(30) Foreign Application Priority Data
Jan. 18, 2013 (DE) 10 2013 100 544.6

(51) Int. Cl. B63C 11/46; A63B 35/12; B63H 21/17

(52) U.S. Cl. CPC B63C 11/46; B63H 21/17; A63B 35/12

(57) ABSTRACT

A watercraft comprises a hull which has a flow channel and a motor-operated water accelerating arrangement paired with the flow channel. The aim of the disclosure is to allow a dynamic manner of travel, in particular a quick changeover between surface travel and submerged travel, using such a watercraft. According to the disclosure, this is achieved in that the hull has a flooding chamber which is connected to the surroundings via water inlet and water outlet openings.

The invention relates to a watercraft having a hull which has a flow duct or which is assigned a flow duct, wherein the flow duct is assigned a motor-driven water acceleration arrangement, in particular a propeller.

A watercraft of said type is known from DE 10 2004 049 615 A1. Watercraft of said type are used in particular as diver propulsion vehicles. They have a handle arrangement which can be gripped by a user while the user lies with a subregion of his or her torso on the top side of the hull of the watercraft. Arranged within the hull is a flow duct in which a propeller is accommodated. The propeller is driven by an electric motor which is supplied with electricity by way of a battery. During operational usage, the battery and the motor generate waste heat which must be dissipated into the surroundings in order to be able to maintain reliable continuous operation. For this purpose, the batteries are inserted into an aluminum housing, wherein the batteries are in heat-conducting contact with the aluminum housing. The hull has a receptacle on the underside, wherein the aluminum housing can be inserted into and locked in said receptacle. In this way, the aluminum housing is in contact, at the underside, with the flowing water, and dissipation of heat can take place here.

For the purposes of cooling, the electric motor is arranged within the flow duct. The water that is conducted through the flow duct is conducted around a housing of the electric motor, whereby effective motor cooling is made possible. The electric motor restricts the free flow cross section in the flow duct. The flow duct must therefore be of adequately large dimensions in order to compensate for the shadow created by the electric motor. This influences the structural size of the watercraft.

With the known watercraft, in order that both underwater travel and above-water travel are possible, precise taring in terms of weight is necessary. Accordingly, the watercraft should generate sufficient buoyancy that it is adequately capable of floating and consequently cannot sink. The buoyancy should however not be too great, in order that a rapid changeover from above-water travel to submerged travel is possible. Owing to the inherent weight of the electrical components, the watercraft must, in the hull, have an adequately large buoyancy body, which influences the structural size and thus the traveling dynamics of the watercraft.

It is an object of the invention to provide a watercraft of the type mentioned in the introduction which, while having adequate operational reliability, offers good traveling dynamics.

Said object is achieved in that the hull has a flooding chamber which is connected to the surroundings via water passage openings, in particular water inlet and water outlet openings.

The flooding chamber consequently provides a variable mass component, by means of which the inherent weight of the watercraft can be influenced. The flooding chamber fills up during operation. When diving with the watercraft, air is forced out of the flooding chamber, and the watercraft can dive rapidly and easily. When the watercraft is lifted out of the water after use, the flooding chamber empties, and does not influence the transport weight of the watercraft.

In a preferred variant of the invention, it may be provided that at least one electrical component is arranged in the flooding chamber. The flooding chamber is consequently additionally used for the cooling of the electrical component. The electrical component can dissipate its heat losses to the water flowing in the flooding chamber. An effective exchange of heat is possible in particular because the flooding chamber is connected to the surroundings both via water inlet openings and via water outlet openings. Consequently, a flow can be generated in the flooding chamber, by means of which cool water is continuously replenished. In a manner dependent on the traveling speed of the watercraft, it is then also possible for the flow speed in the flooding chamber to vary. This has the advantage that, during fast travel, in the case of which high heat losses are also generated, a large cooling volume is available.

As electrical component, it is for example possible for the control electronics, the electric motor which drives the water acceleration arrangement, and/or an energy store to be arranged in the flooding chamber. Said components generate relatively high power losses and are therefore particularly suitable for use in the flooding chamber.

A simple design for the watercraft is attained if it is provided that the hull has an upper part and a lower part, between which the flooding chamber is formed, and if the upper part and/or the lower part at least regionally form the outer shell of the hull.

It may advantageously be provided that the lower part is detachably connected to the upper part. It is then possible for the flooding chamber to be made accessible for the purposes of straightforward maintenance. For example, if dirt has infiltrated into the flooding chamber, said dirt can be easily removed again. If electrical components are arranged in the flooding chamber, these can be easily serviced or exchanged after the lower part has been removed.

An effective flow through the flooding chamber can be attained by virtue of the hull forming at least one inlet opening in the region of the bow and at least one outlet opening in the region of the rear end.

A preferred design variant of the invention is such that the flow duct is arranged at least regionally in the region of the flooding chamber and narrows the free cross section of the flooding chamber, and that an electrical component is arranged in the region of the narrowed cross section. By means of the cross-sectional narrowing, the flow speed in the flooding chamber can be varied. Accordingly, the flow speed regionally increases in the narrowed cross section, such that the cooling power can be influenced in this way.

It is also conceivable that, in the flooding chamber, two subregions are structurally delimited with respect to one another, wherein each subregion is assigned a water inlet and/or water outlet opening. By this measure, too, it is possible in targeted fashion for the volume flow in the individual subregions, and thus the cooling power, to be influenced.

A particularly preferred refinement of the invention is such that the flow duct at least regionally delimits two subregions in the flooding chamber with respect to one another, and that an electrical component is arranged in each of the subregions. By virtue of the fact that the flow duct is used for regional delimitation, the expenditure on parts can be reduced.

One possible design variant of the invention is such that the electrical component is fastened by a suspension means, and that the suspension means holds the electrical component spaced apart from the wall elements which delimit the flooding chamber. In this way, it is possible to realize a flow around the electrical component over a large area, and in association therewith, an effective dissipation of heat.

A preferred refinement of the invention provides that, when the flooding chamber is flooded, the watercraft has a buoyancy of at least 4 kilograms. In this way, the watercraft is kept adequately buoyant even when at sea. It is particularly advantageous if the buoyancy of the watercraft amounts to at least 7 kilograms. Then, even in the event of damage, an adequate buoyancy force can be provided which keeps both the watercraft and the user buoyant.

The invention will be discussed in more detail below on the basis of an exemplary embodiment illustrated in the drawings, in which:

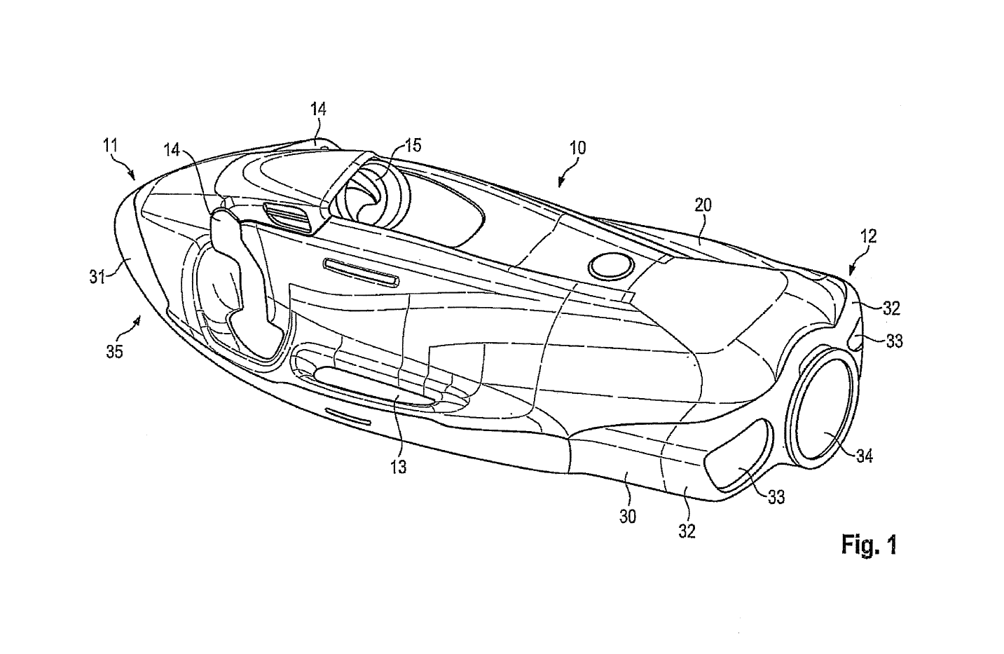

FIG. 1 shows a watercraft in a perspective side view from the rear,

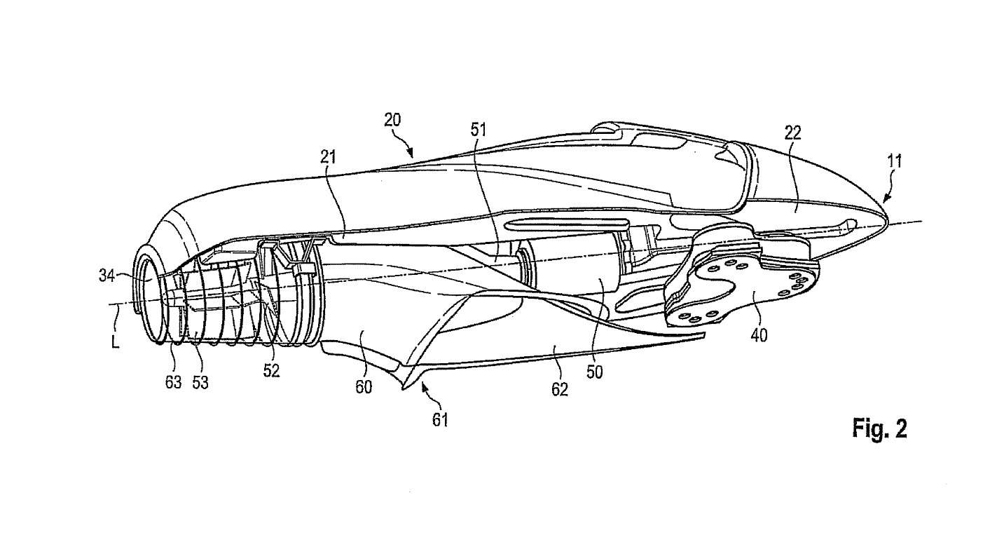

FIG. 2 shows the watercraft as per FIG. 1 in a perspective side view from below and with the lower part removed,

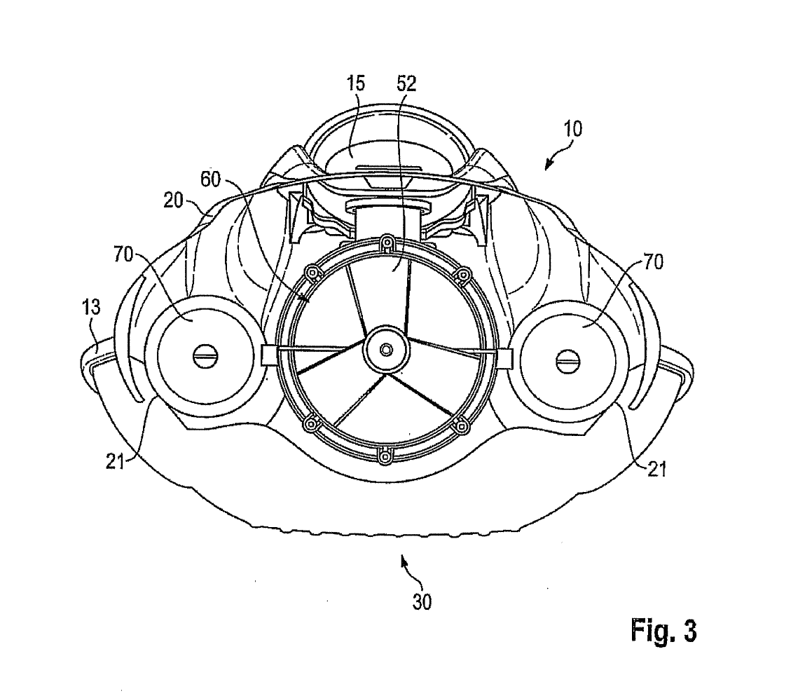

FIG. 3 shows a vertical section through the rear-end region of the watercraft as per the view in FIG. 2, and

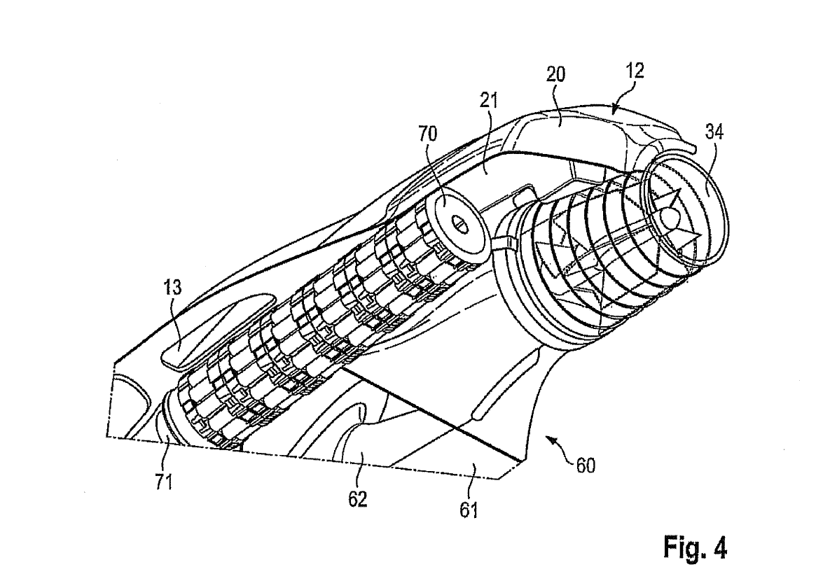

FIG. 4 shows the watercraft as per FIG. 2 in a detail view from below.

FIG. 1 shows a watercraft which has a hull 10. In this case, the hull 10 is made up of an upper part 20 and a lower part 30. The upper part is equipped with two control handles 14 which are arranged on both sides of the hull 10. A user can grip said control handles 14 and can control the watercraft by way of operating elements attached to the control handles 14. In particular, it is possible here for the motor power of the watercraft to be varied. The user, gripping the control handles 14, lies by way of his or her torso regionally on the upper part 20 in the region behind a display 15.

As can be seen from FIG. 2, the lower part 30 can be dismounted from the upper part 20. For this purpose, the lower part is screwed onto the upper part 20. FIG. 2 shows the watercraft with the lower part 30 removed. As can be seen from this illustration, a receiving space is consequently formed between the upper part 20 and the lower part 30. Said receiving space is delimited toward the top side by a base wall 22 of the upper part 20. Components of the watercraft can be mounted in stable fashion on said base wall 22.

As can be seen from FIG. 2, control electronics 40 are mounted in the region of the bow 11 of the watercraft. A drive unit in the form of an electric motor 50 is accommodated, in protected fashion in a housing, behind the control electronics 40 so as to be offset in the direction of the rear end 12. The output shaft of the motor 50 is led through a casing pipe 51 and bears a propeller 52 on its free end. The propeller 52 is arranged in a flow duct 60. In this case, the flow duct 60 is formed by a hollow body which forms an intake opening 61 in the region of the underside of the watercraft. Said intake opening 61 is stabilized by way of a guide element 62 arranged centrally in the intake opening 61. In addition to its mechanical protective function, the guide element 62 has the task of stabilizing the traveling operation. It acts similarly to the fin of a sailing boat. Furthermore, the guide element 62 also protects the flow duct 61 against mechanical load in the region of the intake opening when the watercraft runs aground or is set down on land. As has already been mentioned above, in the region between the upper part 20 and the lower part 30, a receiving chamber is formed below the base wall 22, in which receiving chamber the electrical components, specifically the control electronics 40, the motor 50 and the energy stores 70 (batteries), are accommodated. Said receiving chamber is connected via water passage openings to the surroundings. In this case, the water passage openings are formed in the lower part 30. As can be seen from FIG. 1, the water passage openings are in the form of water inlet openings 35 in the region of the bow 11 and in the form of water outlet openings 33 in the region of the rear end 12. The receiving chamber consequently forms a flooding chamber. When the watercraft is placed into the water, said flooding chamber is flooded with water, which enters through the water passage openings. When the watercraft commences traveling operation, a flow is generated in the flooding chamber. Accordingly, water enters the flooding chamber through the water inlet openings 35. The water flows through the flooding chamber and, in the process, washes around the electrical components that are held in the flooding chamber. In the process, the water absorbs the power losses from the electrical components and cools the latter. After flowing through the flooding chamber, the water exits the latter through the water outlet openings 33, which are arranged symmetrically on both sides of the jet outlet 34.

It can also be seen from FIG. 2 that the flow duct 60 runs in the region of the flooding chamber and regionally delimits two subregions of the flooding chamber with respect to one another. In each case one energy store (battery) is arranged in each of the subregions. Each of the subregions also has one of the two water outlet openings 33. The electrical components are mounted on the base wall 22 of the upper part 20 by suspension means. Here, the suspension means are selected such that, at the regions via which heat losses are dissipated, the electrical components are held spaced apart from the base wall 22. Thus, the water in the flooding chamber can flow effectively around the components here. It has been found that the arrangement of the flow duct 60 in the flooding chamber results in a narrowing of the cross section of the flooding chamber. An increase of the flow speed in the narrowed region is achieved in this way. By means of this speed variation, it is possible for the water flow, and thus the cooling action, to be targetedly set in a manner dependent on the electrical component to be cooled. In the present exemplary embodiment, the energy stores 70 are arranged in the region of the narrowed cross sections in the subregions.

At its end averted from the intake opening 61 in the flow direction, the hollow body forms a flange region on which an in impeller housing 63 can be flange-mounted. The propeller 52 projects into the impeller housing 63. A flow stator 53 is arranged behind the propeller 52 in the flow direction. During operation, the propeller 52 draws water into the flow duct 16 through the intake opening 61, accelerates said water and discharges it through the impeller housing 63 in the region of a jet outlet 34. In this case, the stator 53 has the task of straightening the rotating water movement, such that, for the purposes of improving efficiency, the flow emerges with the least possible swirl at the jet outlet.

As can be seen from FIG. 1, the upper part 20 has receptacles 21 in the region of the base wall 22. Said receptacles 21 are arranged on both sides of the flow duct 60.

It can be seen from FIG. 3 that the receptacles 21 are arranged on both sides of the central longitudinal plane, running through the central longitudinal axis L (see FIG. 2), of the watercraft. The central longitudinal plane runs vertically in FIG. 3. The assignment of the two receptacles 21 to the central longitudinal plane is selected so as to yield a symmetrical design. Energy stores 70, which in the present case are in the form of electrical batteries, can be arranged in the receptacles 21. Owing to the symmetrical arrangement of the receptacles 21, the energy stores 70 are also arranged symmetrically with respect to the central longitudinal plane.

FIG. 4 shows the arrangement of the energy stores 70 in the receptacles 21. As shown in FIG. 4, the receptacle 21 is dimensioned so as to be longer in the longitudinal direction L of the watercraft than the extent of the energy store 70 in said direction. Consequently, the receptacle 21 provides space for the alternative installation of a different energy store 70 which is of correspondingly larger design and which consequently has a higher power output.

1. A watercraft having a hull which has a flow duct or which is assigned a flow duct,
wherein the flow duct is assigned a motor-driven water acceleration arrangement, in particular a propeller,
wherein the hull has a flooding chamber which is connected to the surroundings via water passage openings (water inlet and water outlet openings).

2. The watercraft as claimed in claim 1, wherein
at least one electrical component is arranged in the flooding chamber.

3. The watercraft as claimed in claim 1, wherein
the electrical component is control electronics, an electric motor and/or an energy store.

4. The watercraft as claimed in claim 1, wherein
in that the hull has an upper part and a lower part, between which the flooding chamber is formed, and in that the upper part and/or the lower part at least regionally form the outer shell of the hull.

5. The watercraft as claimed in claim 1,
wherein the lower part is detachably connected to the upper part.

6. The watercraft as claimed in claim 1, wherein
the hull forms at least one inlet opening in the region of the bow and at least one outlet opening in the region of the rear end.

7. The watercraft as claimed in claim 1, wherein
the flow duct is arranged at least regionally in the region of the flooding chamber and narrows the free cross section of the flooding chamber, and in that an electrical component (energy store) is arranged in the region of the narrowed cross section.

8. The watercraft as claimed in claim 1, wherein
the flow duct at least regionally delimits two subregions in the flooding chamber with respect to one another, and in that an electrical component (energy store) is arranged in each of the subregions.

9. The watercraft as claimed in claim 1,
wherein, in the flooding chamber, two subregions are structurally delimited with respect to one another, wherein each subregion is assigned a water inlet and/or water outlet opening.

10. The watercraft as claimed in claim 1, wherein
the electrical component is fastened by a suspension means, and in that the suspension means holds the electrical component spaced apart from the wall element which delimits the flooding chamber.

11. The watercraft as claimed in claim 1, wherein
when the flooding chamber is flooded, said watercraft has a buoyancy of at least 4 kilograms, preferably 7 kilograms.
